(19) United States
(12) Patent Application Publication
(10) Pub. No.: US 2011/0234994 A1
(43) Pub. Date: Sep. 29, 2011

(54) PROJECTOR DEVICE AND PROJECTION METHOD THEREOF

(75) Inventor: Yoshiteru Uchiyama, Suwa-shi (JP)

(73) Assignee: Seiko Epson Corporation, Tokyo (JP)

(21) Appl. No.: 13/050,168

(22) Filed: Mar. 17, 2011

(30) Foreign Application Priority Data
Mar. 26, 2010 (JP) 2010-072423

(51) Int. Cl. G03B 21/14

(52) U.S. Cl. 353/70; 353/121

(57) ABSTRACT

A projector device includes: a light modulating element which modulates light from a light source section according to an image signal; a projecting section which projects a modulation light modulated by a displayable region in a surface of an effective region of the light modulating element onto a projection surface; a trapezoidal distortion correcting section which corrects trapezoidal distortion of a projection image projected onto the projection surface by projecting a light modulation image by means of the displayable region by an after-correction image region which is a part of the effective region of the light modulating element; and a position adjusting section which adjusts the position of the projection image projected onto the projection surface by moving the after-correction image region in the surface of the effective region while maintaining the size and shape of the after-correction image region.

### BACKGROUND

1. Technical Field

The present invention relates to a projector device which has a trapezoidal distortion correcting function which corrects trapezoidal distortion of a projection image projected on a projection surface, and a projection method thereof.

2. Related Art

In the related art, there has been known a projector device which corrects trapezoidal distortion of a projection image projected on a projection surface by correcting an image in a displayable region of a light modulating element which modulates light from a light source (refer to JP-A-2006-005534).

The projector device reduces and corrects the image in the displayable region of the light modulating element according to an after-correction image region of the light modulating element corresponding to an outline of the projection surface in a state where an entire projection region projected from an entire surface of the light modulating element is enlarged to cover the projection surface (screen), and corrects trapezoidal distortion of the projection image. At this time, respective pixels of the light modulating element in which the image in the displayable region is reduced for correction and the image is not projected for display are controlled to be all displayed as a black image so as not to transmit light from the light source.

In this regard, as a technique to adjust the position of a projection image projected on a projection surface, a lens shift function of a zoom lens or a technique of changing an installation angle of a projector device itself has been studied. However, in such a technique, a projection light axis with respect to the projection surface is changed, thereby causing remarkable trapezoidal distortion in the projection image. Thus, if the position of the projection image is adjusted after the trapezoidal distortion is corrected, such a trapezoidal distortion correcting process should be repeated, thereby making the process complicated. Further, such a mechanical adjusting technique does not provide a minute position adjustment, thereby making it difficult to perform adjustment according to a user's wish.

### SUMMARY

An advantage of some aspects of the invention is that it provides a projector device and a projection method thereof which can easily and appropriately perform a position adjustment of a projection image after trapezoidal distortion correction.

According to an aspect of the invention, there is provided a projector device including: a light modulating element which modulates light from a light source section according to an image signal; a projecting section which projects a modulation light modulated by a displayable region in a surface of an effective region of the light modulating element onto a projection surface; a trapezoidal distortion correcting section which corrects trapezoidal distortion of a projection image projected onto the projection surface by projecting a light modulation image by means of the displayable region by an after-correction image region which is a part of the effective region of the light modulating element; and a position adjusting section which adjusts the position of the projection image projected onto the projection surface by moving the after-correction image region in the surface of the effective region while maintaining the size and shape of the after-correction image region.

According to another aspect of the invention, there is provided a projection method of a projector device which includes a light modulating element which modulates light from a light source section according to an image signal and projects a modulation light modulated by a displayable region in a surface of an effective region of the light modulating element onto a projection surface, the method including: correcting trapezoidal distortion of a projection image projected onto the projection surface by projecting a light modulation image by means of the displayable region by an after-correction image region which is a part of the effective region of the light modulating element; and adjusting the position of the projection image projected onto the projection surface by moving the after-correction image region in the surface of the effective region while maintaining the size and shape of the after-correction image region.

According to these configurations, since the after-correction image region is moved by the position adjusting section, it is possible to adjust the position of the projection image without changing a projection light axis with respect to the projection surface. Thus, since a large trapezoidal distortion is not generated in the projection image after the position adjustment, it is possible to simplify the image processing without repeatedly correcting the trapezoidal distortion after the position adjustment. Further, since the after-correction image region on the light modulating element moves in the effective region while maintaining the size and shape thereof, it is possible to easily perform the image processing according to the position adjustment, to perform the movement in units of pixels of the light modulating element, and to accurately perform a minute position adjustment of the projection image. Further, it is possible to effectively utilize pixels which are not used in a region other than the after-correction image region in the effective region of the light modulating element.

In this case, the position adjusting section may move the after-correction image region with at least two corners thereof being in internal contact with the effective region.

According to these configurations, the after-correction image region can occupy the maximum area in the effective region, and thus, it is possible to effectively use the light modulating element to the maximum.

Further, the projector device may further include a manipulation section which adjusts the movement amount of the after-correction image region in the effective region after the projection image is projected, and the position adjusting section may adjust the position of the projection image according to manipulation of the manipulation section.

According to this configuration, it is possible to adjust the position of the projection image by a user desired amount according to a user's manipulation.

In this case, the manipulation section may include a longitudinal manipulation section which is manipulated when a longitudinal trapezoidal distortion correction is performed by the trapezoidal distortion correcting section and a transverse manipulation section which is manipulated when a transverse trapezoidal distortion correction is performed by the trapezoidal distortion correcting section.

According to this configuration, it is possible to adjust the position of the projection image with intuitive manipulation through two manipulation sections of the longitudinal manipulation section and the transverse manipulation section.

In this case, the manipulation section may include a knob movable manipulator which adjusts the movement amount of the after-correction image region using a displacement amount of a knob.

According to this configuration, since the adjustment can be performed using the displacement amount of the knob, it is possible to continuously adjust the position of the projection image. Further, the knob movable manipulator may employ any one of a linear knob type in which a knob moves (slides) linearly and a rotary knob type in which a knob rotates.

Further, the manipulation section may include a lever type manipulator which adjusts the movement direction and the movement amount of the after-correction image region using the inclination direction and inclination amount of a lever.

According to this configuration, since the adjustment can be performed using the inclination direction and inclination amount of the lever, it is possible to intuitively and continuously adjust the position of the projection image. Further, the lever type manipulator may employ a joy stick, a cross lever, or the like.

### BRIEF DESCRIPTION OF THE DRAWINGS

The invention will be described with reference to the accompanying drawings, wherein like numbers reference like elements.

FIG. 1 is a block diagram illustrating a control configuration of a projector device.

FIG. 2A is a diagram illustrating an image and a projection image in a displayable region of a light modulating element before a trapezoidal distortion correction process, and FIG. 2B is a diagram illustrating an image and a projection image in a displayable region of a light modulating element after a trapezoidal distortion correction process.

FIG. 3A is a front view of a manipulation panel and FIG. 3B is an enlarged perspective view illustrating a position adjusting knob.

FIG. 4 is a perspective view schematically illustrating a remote controller of a projector device.

FIG. 5 is a flowchart illustrating a projection process of a projector device.

FIG. 6A is a diagram illustrating an image and a projection image in a displayable region of a light modulating element before a position adjusting process in the longitudinal direction, and FIGS. 6B and 6C are diagrams illustrating an image and a projection image in a displayable region of a light modulating element after a position adjusting process.

FIG. 7A is a diagram illustrating an image and a projection image in a displayable region of a light modulating element before a position adjusting process in the transverse direction, and FIGS. 7B and 7C are diagrams illustrating an image and a projection image in a displayable region of a light modulating element after a position adjusting process.

FIG. 8A is a diagram illustrating an image and a projection image in a displayable region of a light modulating element before a position adjusting process in the longitudinal and transverse directions, and FIG. 8B is a diagram illustrating an image and a projection image in a displayable region of a light modulating element after a position adjusting process.

### DESCRIPTION OF EXEMPLARY EMBODIMENTS

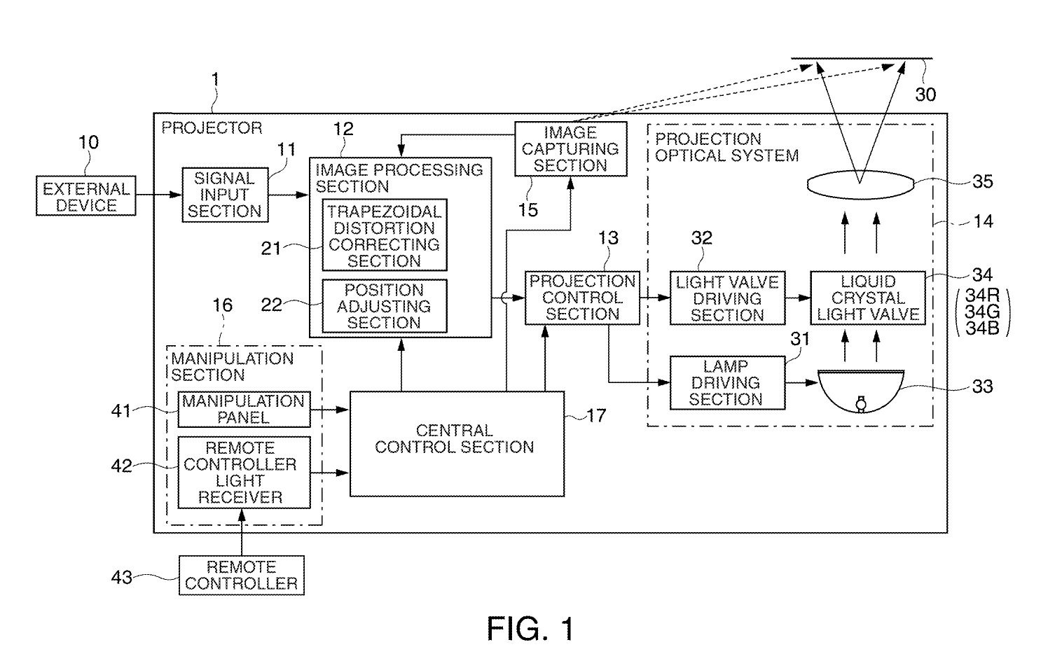

Hereinafter, a projector device and a projection method thereof according to an embodiment of the invention will be described with reference to the accompanying drawings. FIG. 1 is a block diagram illustrating a configuration of a projector device 1. As shown in the figure, the projector device 1 includes a signal input section 11, an image processing section 12, a projection control section 13, a projection optical system 14, an image capturing section 15, a manipulation section 16, and a central control section 17 which controls overall the above sections.

The signal input section 11 receives an image signal from an external device 10 such as a personal computer or a video recorder. That is, the signal input section 11 is realized by an interface which receives an RGB signal output from the personal computer or a composite signal output from the video recorder. In this embodiment, the image signal is received from the external device 10 through the signal input section 11, but a configuration in which it is detected whether a recording medium (USB memory or SD memory card) is inserted or the image signal is read out from the recording medium may be used.

The image processing section 12 performs a predetermined process on the basis of an image processing program stored in advance, with respect to the image signal input through the signal input section 11. A light modulation image data is generated from the image signal through the predetermined process, and a light modulation image 100 (image in a displayable region) is projected from a liquid crystal light valve 34 (light modulating element) which will be described later, on the basis of the light modulation image data. A region on the light modulating element corresponding to the light modulation image 100 is assumed as a displayable region 54.

The image processing section 12 includes a trapezoidal distortion correcting section 21 which performs a trapezoidal distortion correcting process, and a position adjusting section 22 which performs an image position adjusting process. Further, the image processing section 12 includes respective processing sections which perform processes (for example, a screen size adjusting process, an image quality adjusting process, a gamma correcting process, an image composing process, and the like) other than the above processes (not shown).

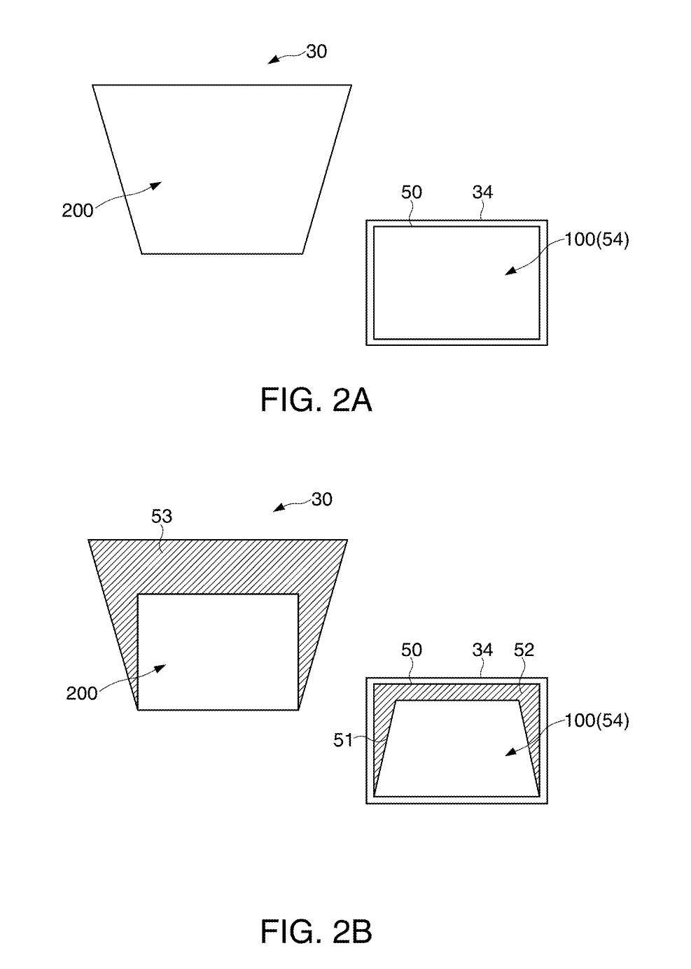

In a case where there exists trapezoidal distortion to a projection image 200 projected to a projection surface 30, the trapezoidal distortion correcting section 21 corrects the light modulation image data to thereby perform the trapezoidal distortion correcting process. Specifically, the image captured data transmitted by the image capturing section 15 which will be described later is processed and the amount of position offsets of four corners of the projection image 200 with respect to a projection frame (screen frame) of the projection surface 30 is calculated, and thus, it is determined whether the trapezoidal distortion is generated or not. Then, in order to change the trapezoidal shape of the projection image 200 into a rectangular shape, the light modulation image 100 (displayable region 54) is projected from an after-correction image region 51 which is a part of an effective region 50 of the liquid crystal light valve 34, to thereby correct the trapezoidal distortion of the projection image 200 (refer to FIG. 2B). The trapezoidal distortion correcting process may not be automatically performed, and a user may manipulate the manipulation section 16 to perform the trapezoidal distortion correction.

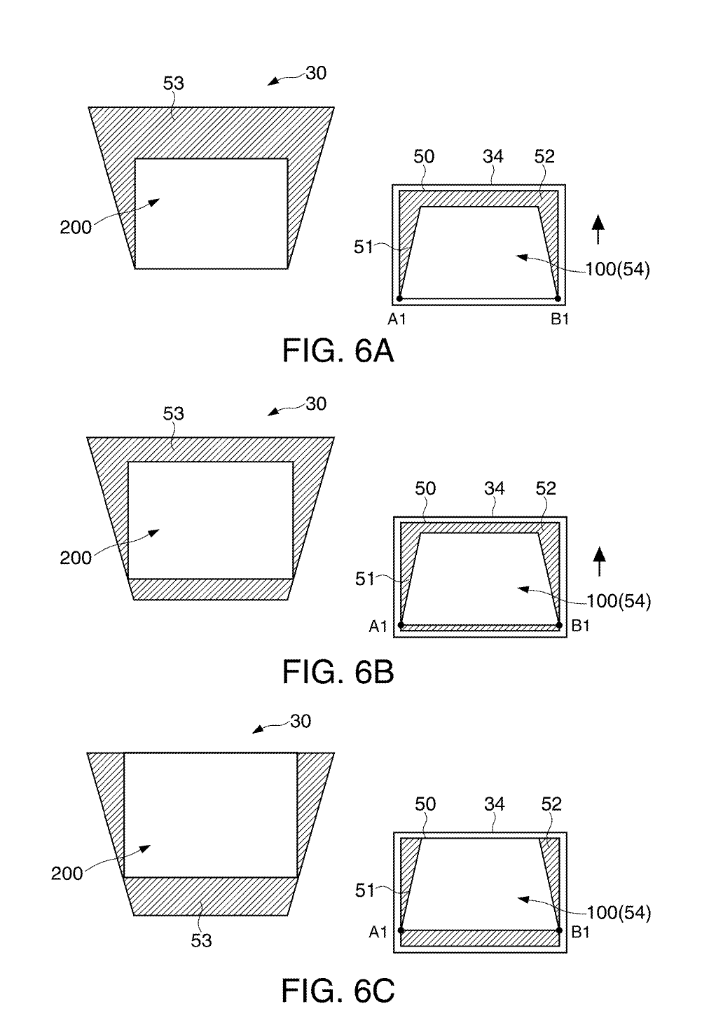

After the trapezoidal distortion correcting process is completed by the trapezoidal distortion correcting section 21, the position adjusting section 22 moves the after-correction image region 51 in the effective region 50 of the liquid crystal light valve 34 to thereby perform adjustment of the projection position of the projection image 200. In this case, the position adjusting section 22 moves the after-correction image region 51 while maintaining the size and shape thereof (refer to FIGS. 6A to 8B).

The projection control section 13 calculates a grayscale value corresponding to each pixel of the liquid crystal light valve 34 (light modulating element) on the basis of the light modulation image data generated by the image processing section 12, and performs a projection control on the basis of grayscale values of all pixels.

The projection optical system 14 projects the projection image 200 on the projection surface 30, and includes a lamp driving section 31, a light valve driving section 32, a light source section 33, the liquid crystal light valves 34 (34R, 34G, and 34B) corresponding to the three primary colors, and a projection lens 35.

Each liquid crystal light valve 34 is formed, for example, by a liquid crystal display panel in which liquid crystals are sealed between a pair of transparent substrates. On an inner surface of each transparent substrate, a transparent electrode capable of applying a driving voltage to the liquid crystal for every minute region is formed in a matrix format as a pixel. The light valve driving section 32 applies the driving voltage according to the light modulation image data (grayscale values of all pixels) to each pixel of the liquid crystal light valve 34, to thereby set the light transmittance of each pixel to display the light modulation image 100.

The light source section 33 can employ a halogen lamp, a metal halide lamp, or a high-pressure mercury lamp. Further, a solid light source such as laser or LED may be used instead. The lamp driving section 31 turns on the light source section 33 on the basis of a turn-on command from the projection control section 13.

An illumination light emitted from the light source section 33 is separated into color lights of R, G, and B by a light separation optical system (not shown) and is modulated by passing through the liquid crystal light valve 34 for each color. The modulated light (light modulation image 100) is composed for every pixel by a light composing optical system (not shown, a dichroic prism or the like) to be color-imaged, and the color image light which is color-imaged is projected through the projection lens 35, and the colored projection image 200 is displayed on the projection surface 30.

Further, instead of the above-described liquid crystal display method, other methods may be applied to the projection optical system 14. Specifically, there is a projection method using a DMD (Digital Micro mirror Device), that is, a so-called DLP (Digital Light Processing) method. Here, the DLP method refers to a method of collecting the light of a white glow lamp using a lens to direct the light to the DMD, and enlarging the light when each mirror of the DMD is inclined in a turned on state using a different lens to project the light to a screen, to which the invention can be applied.

The image capturing section 15 is configured by a CCD camera or the like, and captures the projection image 200 which is projected on the projection surface 30. The image captured data is transmitted to the image processing section 12, and the trapezoidal distortion correcting process is performed on the basis of the image captured data by the trapezoidal distortion correcting section 21.

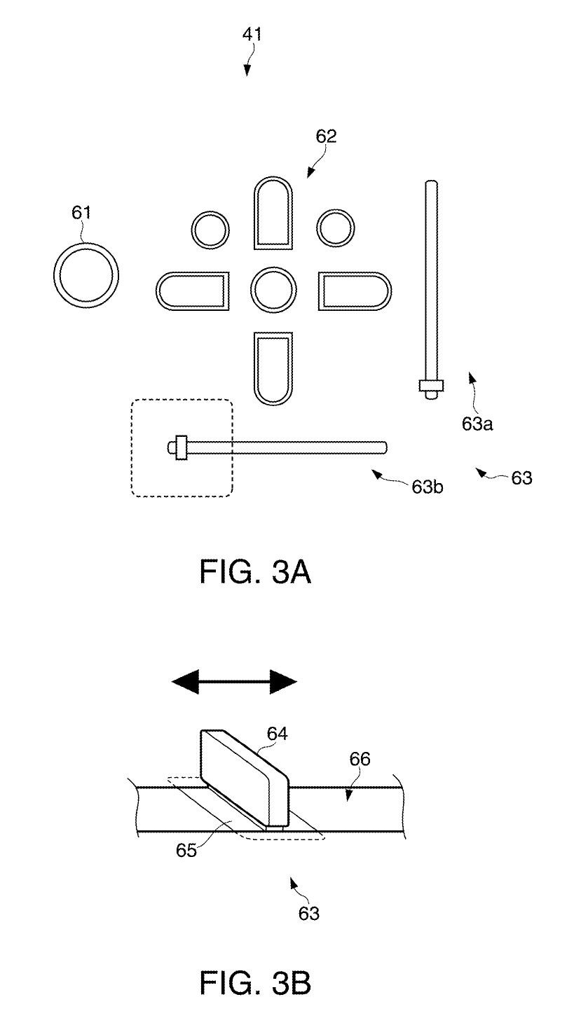

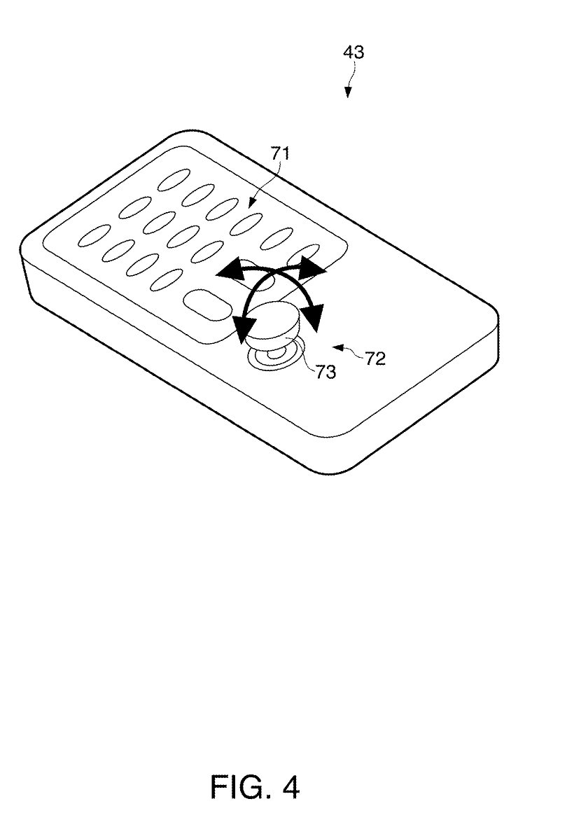

The manipulation section 16 is a section in which a variety of settings and manipulations are performed by a user, and includes a manipulation panel 41 installed on a main body of the projector device 1, a remote controller light receiver 42, and a remote controller 43. A position adjusting knob 63 for adjusting the position of the projection image 200 is installed on the manipulation panel 41 (refer to FIGS. 3A and 3B). On the other hand, a position adjusting stick 72 is installed on the remote controller 43 (refer to FIG. 4).

The central control section 17 is configured by a CPU (Central Processing Unit), a ROM (Read Only Memory), a RAM (Random Access Memory), and the like (none of them not shown), and controls the entire projector. A specific process (projecting process) of the central control section 17 will be described later.

Here, the trapezoidal distortion correcting process of the image will be described with reference to FIGS. 2A and 2B. FIGS. 2A and 2B illustrate the light modulation image 100 (displayable region 54) displayed in the effective region 50 of the liquid crystal light valve 34 and the projection image 200 in which the light modulation image 100 is projected to the projection surface 30. As shown in FIG. 2A, the trapezoidal distortion is generated in the projection image 200 to which the light modulation image 100 is projected (in the figure, longitudinal trapezoidal distortion). As shown in FIG. 2B, the trapezoidal distortion correcting section 21 corrects the light modulation image data and deforms the light modulation image 100 so that the light modulation image 100 has a shape in which the trapezoidal distortion of the projection image 200 is compensated. Thus, the projection image 200 is changed from the trapezoidal shape to the rectangular shape, and thus, the trapezoidal distortion is removed. At this time, the trapezoidal distortion correcting section 21 corrects the light modulation image data so that the area of the light modulation image 100 (displayable region 54) after deformation in the effective region 50 becomes the maximum. The region where the deformed light modulation image 100 (displayable region 54) is displayed is the after-correction image region 51.

However, in the effective region 50 of the liquid crystal light valve 34 after the trapezoidal distortion correcting process, an image mask region 52 which is a different region from the displayable region 54 displays a black image by lowering the light transmittance by a combination of a polarization plate in order not to transmit the projection light. In addition, in the projection surface 30, a projection mask region 53 to which the black image of the image mask region 52 is projected is present. The image mask region 52 is a pixel region generated by reducing at least a part of the light modulation image 100 to compensate for the trapezoidal distortion of the projection image 200, and in actuality, is an image displayable region. Accordingly, the projection mask region 53 is an image projectable region. The position adjusting section 22 of this embodiment performs the position adjustment of the projection image 200 by using the image mask region 52 and moving the after-correction image region 51.

Next, a position adjusting manipulation function of the projection image 200 in the manipulation section 16 of the projector device 1 will be described with reference to FIGS. 3A, 3B, and 4. FIG. 3A illustrates the manipulation panel 41 installed on the main body of the projector device 1. The manipulation panel 41 includes a power button 61, a button group 62 through which a variety of manipulations is performed, and a position adjusting knob 63 for adjusting the projection position of the projection image 200.

The position adjusting knob 63 includes a longitudinal manipulation knob 63a which manipulates the projection image 200 in the longitudinal direction (up and down directions), and a transverse manipulation knob 63b which manipulates the projection image 200 in the transverse direction (left and right directions). The longitudinal manipulation knob 63a and the transverse manipulation knob 63b area so-called knob movable manipulator, which includes a knob section 64 which is gripped by a user for manipulation, a slide section 65 which is connected to the knob section 64, and a slide groove 66 in which the slide section 65 slides, as shown in FIG. 3B. The user adjusts the projection position of the projection image 200 by sliding the knob section 64 in a range of the slide groove 66. On the other hand, the position adjusting section 22 of the image processing section 12 adjusts the movement amount of the light modulation image 100 (after-correction image region 51) according to the displacement amount of the slide section 65. Instead of such a linear knob which moves (slides) the knob in a linear direction, the position adjusting knob 63 may be configured by a rotational knob which rotates a knob.

FIG. 4 illustrates the remote controller 43 for remotely controlling the projector device 1. The remote controller 43 includes a remote controller button group 71 through which the same manipulations as the manipulation panel 41 are performed, and a position adjusting stick 72 (lever type manipulator) for adjusting the projection position of the projection image 200. The position adjusting stick 72 is a so-called joy stick, and the user performs the position adjustment of the projection image 200 by inclining a stick section 73 vertically and horizontally. On the other hand, the position adjusting section 22 of the image processing section 12 adjusts the movement direction and the movement amount of the light modulation image 100 (after-correction image region 51) on the basis of the inclination direction and the inclination amount of the stick section 73. The position adjusting stick 72 may be configured as a cross lever in which a stick is manipulated vertically and horizontally, or a cross button capable of changing the adjustment amount by the pressing time corresponding to up, down, left, and right.

In this way, as the position adjusting manipulation function of the projection image is provided in the manipulation section 16, it is possible to adjust the position of the projection image 200 by a user desired amount, according to a manipulation of the user. Further, it is possible to intuitively and continuously adjust the projection position of the projection image 200 by the position adjusting knob 63 and the position adjusting stick 72. The position adjusting stick 72 may be installed on the manipulation panel 41, or the position adjusting knob 63 may be installed on the remote controller 43.

Further, the manipulation section 16 may be configured by a touch pad or a touch panel of an electrostatic capacitance type which is mounted on a typical notebook personal computer. According to such a configuration, space saving of the manipulation section 16 is realized and the user can more intuitively perform the position adjustment of the projection image 200. In particular, if the touch panel capable of detecting a plurality of points is used, it is possible to perform zoom-out and zoom-in using a pinch operation by two-point simultaneous detection on the panel. Thus, longitudinal movement, transverse movement, and enlargement and reduction in the projection image can be manipulated at one time, to thereby enhance manipulation performance.

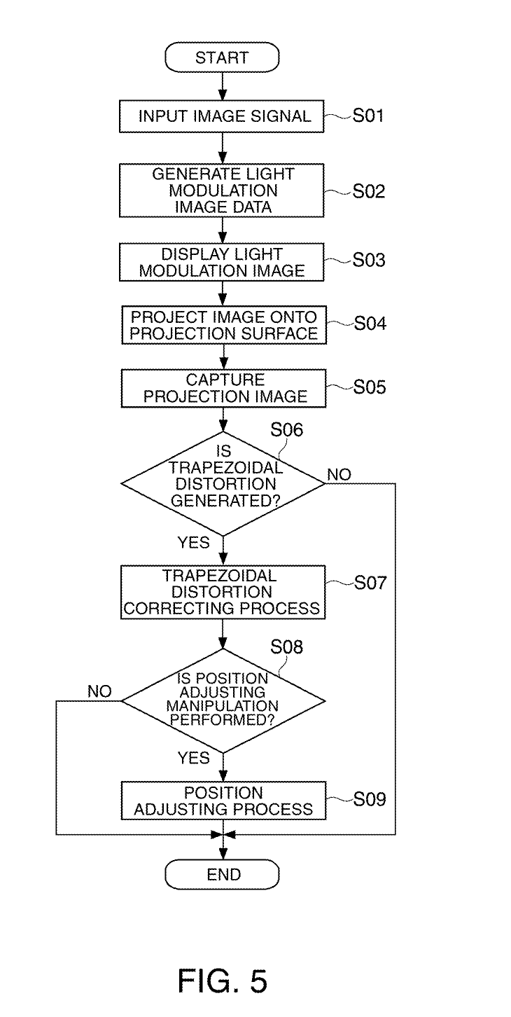

Next, a projection process (projection method) of the projector device 1 will be described with reference to FIG. 5. If an image signal is input through the signal input section 11 (S01), the projector device 1 (central control section 17) performs a predetermined process for the image signal by the image processing section 12 to thereby generate the light modulation image data (502). Then, the light modulation image 100 based on the light modulation image data is displayed on the liquid crystal light valve 34 by the projection control section 13 (S03). The light modulation image 100 is projected onto the projection surface 30 by the projection optical system 14 (SO4). Subsequently, the projection image 200 projected to the projection surface 30 is captured by the image capturing section 15 (505), and the captured image data is transmitted to the image processing section 12, and then it is determined whether the trapezoidal distortion is generated in the projection image 200 (S06).

In a case where the trapezoidal distortion is not generated (S06; NO), the trapezoidal distortion correcting process and the position adjustment processing image process are not performed, and the procedure is terminated. On the other hand, in a case where the trapezoidal distortion is generated in the projection image 200, the trapezoidal distortion correcting process is performed by the trapezoidal distortion correcting section 21 (S07). Then, in a case where the position adjusting manipulation is performed by the manipulation section 16 (S08; YES), the position adjusting process is performed by the position adjusting section 22 (S09), and then the projection process is terminated. Further, in a case where the position adjusting manipulation is not performed (S08; NO), the projection process is terminated as it is.

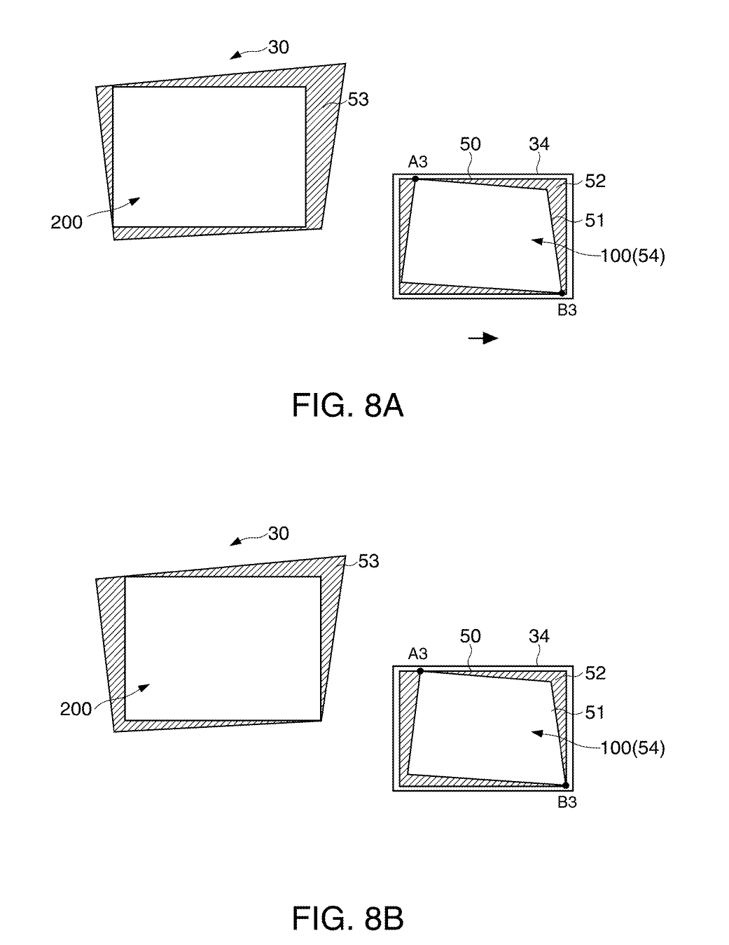

Subsequently, the position adjusting process of the image will be described with reference to FIGS. 6A, 6B, and 6C, to FIGS. 8A and 8B. FIGS. 6A to 6C illustrate the projection image 200 and the light modulation image 100 after the longitudinal trapezoidal distortion of the projection image 200 is corrected. As shown in FIG. 6A, the light modulation image 100 (after-correction image region 51) displayed on the effective region 50 of the liquid crystal light valve 34 has the image mask region 52 on the upper side thereof, and thus is movable upward. The position adjusting section 22 corrects the light modulation image data according to the manipulation of the manipulation section 16 by the user and moves the light modulation image 100 (after-correction image region 51) in the effective region 50 upward and downward. Through the movement of the light modulation image 100, the projection image 200 moves upward and downward as shown in the figure. At this time, the position adjusting section 22 moves the light modulation image 100 with two corners (point A1 and point B1) thereof being in internal contact with the effective region 50 and the size and shape thereof being maintained. Actually, as shown in FIGS. 6A to 6C, if the light modulation image 100 moves upward with two corners thereof being in internal contact with the effective region 50, the projection image 200 is slightly enlarged (refer to FIGS. 6B and 6C).

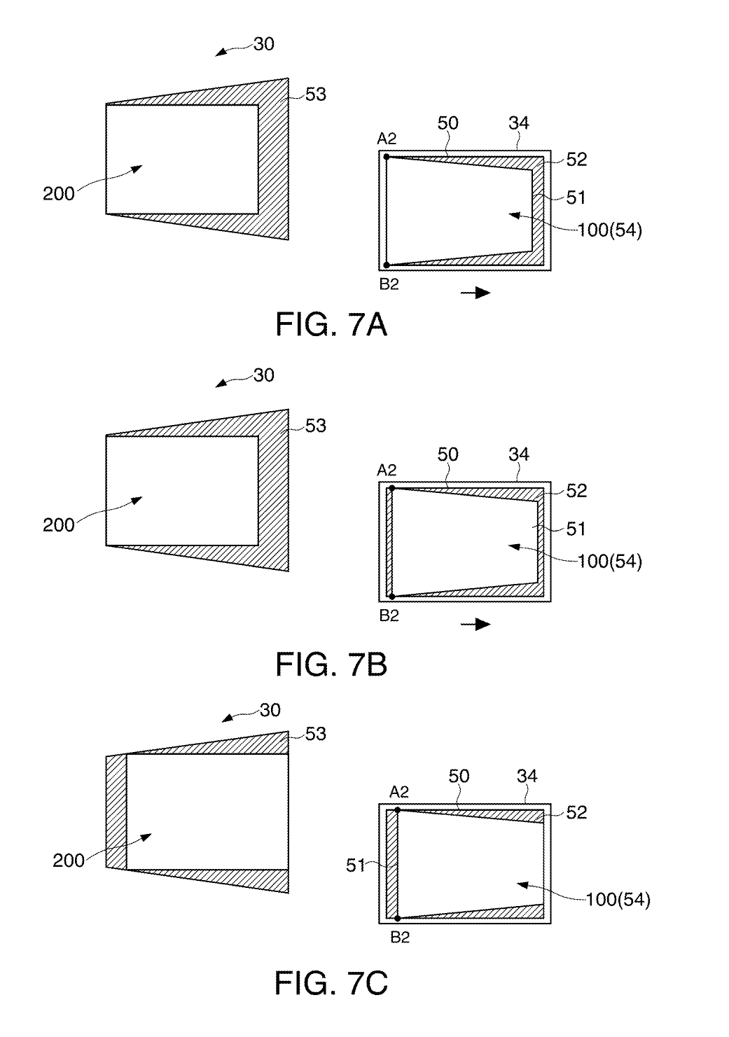

FIGS. 7A to 7C illustrate the projection image 200 and the light modulation image 100 after the transverse trapezoidal distortion of the projection image 200 is corrected. As shown in FIG. 7A, the light modulation image 100 (after-correction image region 51) has the image mask region 52 on the right side, and thus is movable to the right side. The position adjusting section 22 corrects the light modulation image data according to the manipulation of the manipulation section 16 by the user, and moves the light modulation image 100 (after-correction image region 51) in the effective region 50 in the left and right directions. Through the movement of the light modulation image 100, the projection image 200 moves in the left and right directions as shown in the figure. At this time, the position adjusting section 22 moves the light modulation image 100 with two corners (point A2 and point B2) thereof being in internal contact with the effective region 50 and the size and shape thereof being maintained. Actually, as shown in FIGS. 7A to 7C, if the light modulation image 100 moves in the right direction with two corners thereof being in internal contact with the effective region 50, the projection image 200 is slightly enlarged (refer to FIGS. 7B and 7C).

FIGS. 8A and 8B illustrate the projection image 200 and the light modulation image 100 after the longitudinal and transverse trapezoidal distortions are corrected. The light modulation image 100 is movable in the right direction. The position adjusting section 22 corrects the light modulation image data according to the manipulation of the manipulation section 16 by the user, and moves the light modulation image 100 (after-correction image region 51) in the effective region 50 in the left and right directions. Through the movement of the light modulation image 100, the projection image 200 moves in the left and right directions as shown in the figure. At this time, the position adjusting section 22 moves the light modulation image 100 with two corners (point A3 and point B3) thereof being in internal contact with the effective region 50 and the size and shape thereof being maintained. Actually, as shown in FIGS. 8A to 8B, if the light modulation image 100 moves in the right direction with two corners thereof being in internal contact with the effective region 50, the projection image 200 is slightly enlarged (refer to FIGS. 8A and 8B).

As described above, according to the projector device 1 in this embodiment, since the position adjustment of the projection image 200 is performed by correcting the light modulation image data, it is possible to easily perform the position adjustment of the image without repeatedly generating a large trapezoidal distortion in the projection image 200 after the position adjustment. Further, it is possible to perform the movement in units of pixels and to accurately perform a minute position adjustment. Furthermore, since the light modulation image 100 (after-correction image region 51) moves by using the image mask region 52 in the effective region 50, it is possible to effectively utilize the pixels of the liquid crystal light valve 34. Further, since the light modulation image 100 (after-correction image region 51) moves inside the effective region 50 with two corners thereof being in internal contact with the effective region 50, it is possible to constantly maximize the area of the light modulation image 100 in the effective region 50 of the liquid crystal light valve 34, and to prevent deterioration of the projection image 200 by preventing reduction in the number of pixels corresponding to the light modulation image 100. Further, since the light modulation image 100 moves inside the effective region 50 with the size and shape thereof being maintained, the image processing according to the position adjustment becomes easy.

In the above-described embodiment, the size of the projection image 200 is slightly enlarged through the movement of the after-correction image region 51 by the position adjusting section 22, but the reduction processing of the light modulation image 100 may be performed so that the size of the projection image 200 becomes identical before adjustment and after adjustment. That is, in order to perform the position adjustment while maintaining the screen size in the projection surface 30 as the same area, the position adjusting section 22 may perform adjustment so that the light modulation image 100 moves according to the manipulation of the manipulation section 16, and then further corrects the light modulation data to reduce the light modulation image 100 (after-correction image region 51) inwardly while maintaining the image position, so that the projection screen 200 before the movement and the projection screen 200 after the movement have the same area. Further, after the movement of the after-correction image region 51 or at the time of reduction processing of the light modulation image 100, the trapezoidal distortion correction process through the trapezoidal distortion correcting section 21 may be performed again.

It is possible to provide the respective components of the projector device in the above-described embodiment as a program. Further, the program may be stored in a variety of recording mediums (CD-ROM, flash memory, or the like) and provided. That is, a program for allowing a computer to function as the respective components of the projector device, and a recording medium which records this program are included in the scope of the invention. Further, modifications may be made in the range without departing from the spirit of the invention.

What is claimed is:

1. A projector device comprising:
a light modulating element which modulates light from a light source section according to an image signal;
a projecting section which projects a modulation light modulated by a displayable region in a surface of an effective region of the light modulating element onto a projection surface;
a trapezoidal distortion correcting section which corrects trapezoidal distortion of a projection image projected onto the projection surface by projecting a light modulation image by means of the displayable region by an after-correction image region which is apart of the effective region of the light modulating element; and
a position adjusting section which adjusts the position of the projection image projected onto the projection surface by moving the after-correction image region in the surface of the effective region while maintaining the size and shape of the after-correction image region.

2. The projector device according to claim 1,
wherein the position adjusting section moves the after-correction image region with at least two corners thereof being in internal contact with the effective region.

3. The projector device according to claim 1,
further comprising a manipulation section which adjusts the movement amount of the after-correction image region in the effective region after the projection image is projected,
wherein the position adjusting section adjusts the position of the projection image according to manipulation of the manipulation section.

4. The projector device according to claim 3,
wherein the manipulation section includes a longitudinal manipulation section which is manipulated when a longitudinal trapezoidal distortion correction is performed by the trapezoidal distortion correcting section and a transverse manipulation section which is manipulated when a transverse trapezoidal distortion correction is performed by the trapezoidal distortion correcting section.

5. The projector device according to claim 4,
wherein the manipulation section includes a knob movable manipulator which adjusts the movement amount of the after-correction image region using a displacement amount of a knob.

6. The projector device according to claim 3,
wherein the manipulation section includes a lever type manipulator which adjusts the movement direction and the movement amount of the after-correction image region using the inclination direction and inclination amount of a lever.

7. A projection method of a projector device which includes a light modulating element which modulates light from alight source section according to an image signal and projects a modulation light modulated by a displayable region in a surface of an effective region of the light modulating element onto a projection surface, the method comprising:
correcting trapezoidal distortion of a projection image projected onto the projection surface by projecting a light modulation image by means of the displayable region by an after-correction image region which is apart of the effective region of the light modulating element; and
adjusting the position of the projection image projected onto the projection surface by moving the after-correction image region in the surface of the effective region while maintaining the size and shape of the after-correction image region.
